(19) United States
(12) Patent Application Publication
(10) Pub. No.: US 2013/0316162 A1
(43) Pub. Date: Nov. 28, 2013

(54) TEMPERED GLASS PLATE

(71) Applicants: Takashi Murata, Shiga (JP); Kosuke Kawamoto, Shiga (JP)

(72) Inventors: Takashi Murata, Shiga (JP); Kosuke Kawamoto, Shiga (JP)

(73) Assignee: NIPPON ELECTRIC GLASS CO., LTD., Otsu-shi, Shiga (JP)

(21) Appl. No.: 13/983,782

(22) PCT Filed: Feb. 7, 2012
(86) PCT No.: PCT/JP2012/052714

§ 371 Date: Aug. 6, 2013

(30) Foreign Application Priority Data
Feb. 10, 2011 (JP) 2011-026661

(51) Int. Cl. C03C 3/093; C03C 3/087

(52) U.S. Cl. CPC C03C 3/093; C03C 3/087
USPC 428/220; 428/410; 501/66; 501/68

(57) ABSTRACT

Provided is a tempered glass sheet having a compression stress layer in a surface thereof, comprising, as a glass composition expressed in mass % in terms of oxides, 50 to 70% of SiO₂, 5 to 20% of Al₂O₃, 0 to 5% of B₂O₃, 8 to 18% of Na₂O, 2 to 9% of K₂O, and 30 to 1,500 ppm of Fe₂O₃, and having a spectral transmittance in terms of a thickness of 1.0 mm at a wavelength of 400 to 700 nm of 85% or more, a chromaticity x of 0.3095 to 0.3120 in xy chromaticity coordinates (illuminant C, in terms of a thickness of 1 mm), and a chromaticity y of 0.3160 to 0.3180 in xy chromaticity coordinates (illuminant C, in terms of a thickness of 1 mm).

### TECHNICAL FIELD

The present invention relates to a tempered glass sheet, and more specifically, to a tempered glass sheet suitable for a cover glass for a cellular phone, a digital camera, a personal digital assistant (PDA), or a solar cell, or a glass substrate for a display, in particular, a touch panel display.

### BACKGROUND ART

In recent years, a PDA equipped with a touch panel display has been developed, and a tempered glass sheet has been used for protecting a display part thereof. A market for the tempered glass sheet is expected to grow bigger and bigger in the future (see, for example, Patent Literature 1 and Non Patent Literature 1).

The tempered glass sheet for this application is required to have a high mechanical strength.

### CITATION LIST

### Patent Literature

Patent Literature 1: JP 2006-83045 A

### Non Patent Literature

Non Patent Literature 1: Tetsuro Izumitani et al., “New glass and physical properties thereof,” First edition, Management System Laboratory. Co., Ltd., Aug. 20, 1984, p. 451-498

### SUMMARY OF INVENTION

### Technical Problem

Hitherto, there has been employed such a form that, once an end surface of a tempered glass sheet (cover glass) for protecting a display is incorporated into a chassis of a device, a portion of the end surface of the tempered glass sheet cannot be touched by users. However, in recent years, such a form that the tempered glass sheet is attached outside the device has been studied in order to enhance designability. Thus, the end surface of the cover glass has also been considered to be a part of a design.

When apart or the whole of the end surface of the tempered glass sheet is exposed to the outside, it is necessary to take care not to impair appearance of the device. In this case, a color of the tempered glass sheet is important. Specifically, it is important that the tempered glass sheet do not have a bluish or yellowish color when the tempered glass sheet is seen from the end surface side thereof.

Further, in order to enhance a mechanical strength of a tempered glass, a compression stress value of its compression stress layer needs to be increased. A component such as Al₂O₃ is known as a component that is capable of increasing the compression stress value. However, when the content of Al₂O₃ is too large, there is a problem in that an Al₂O₃ raw material is liable to remain unmelted at the time of melting of glass, resulting in many glass defects. When feldspar or the like is used as the Al₂O₂ raw material, the problem can be solved. However, an increased content of Fe₂O₃ in a glass composition due to Fe₂O₃ contained in the feldspar makes it difficult to adjust the color of the glass to a desired one. Further, when a hydrate raw material is used as well, the above-mentioned problem can be solved. However, an increased content of water in the glass makes it difficult to increase the compression stress value.

Thus, a technical object of the present invention is to provide a tempered glass sheet comprising a compression stress layer with a high compression stress value and having a desired color.

### Solution to Problem

The inventors of the present invention have made various studies and have consequently found that the technical object described above can be achieved by controlling the content of each component in a glass composition and glass characteristics within predetermined ranges. Thus, the finding is proposed as the present invention. That is, a tempered glass sheet of the present invention is a tempered glass sheet having a compression stress layer in a surface thereof, comprising, as a glass composition expressed in mass % in terms of oxides, 50 to 70% of SiO₂, 5 to 20% of Al₂O₂, 0 to 5% of B₂O₃, 8 to 18% of Na₂O, 2 to 9% of K₂O, and 30 to 1,500 ppm (0.003 to 0.15%) of Fe₂O₃, and having a spectral transmittance in terms of a thickness of 1.0 mm at a wavelength of 400 to 700 nm of 85% or more, x in xy chromaticity coordinates (illuminant C, in terms of a thickness of 1 mm) of 0.3095 to 0.3120, and y in xy chromaticity coordinates (illuminant C, in terms of a thickness of 1 mm) of 0.3160 to 0.3180. Herein, the phrase “in terms of oxides” means that, when Fe₂O₃ is taken as an example, not only iron oxide present in the state of Fe³⁺ but also iron oxide present in the state of Fe²⁺ are expressed as Fe₂O₃ after being converted to Fe₂O₃ (the same holds true for other oxides). The “spectral transmittance in terms of a thickness of 1.0 mm at a wavelength of 400 to 700 nm” can be measured, for example, at a slit width of 2.0 nm at a medium scan speed at a sampling pitch of 0.5 nm by using UV-3100 PC (manufactured by Shimadzu Corporation). The “x in xy chromaticity coordinates (illuminant C, in terms of a thickness of 1 mm)” can be measured by using, for example, UV-3100 PC (manufactured by Shimadzu Corporation). The “y in xy chromaticity coordinates (illuminant C, in terms of a thickness of 1 mm)” can be measured by using, for example, UV-3100 PC (manufactured by Shimadzu Corporation).

Second, in the tempered glass sheet of the present invention, it is preferred that the compression stress value of the compression stress layer be 400 MPa or more, and the depth (thickness) of the compression stress layer be 30 μm or more. Herein, the term “compression stress value of the compression stress layer” and the term “depth of the compression stress layer” refer to values which are calculated from the number of interference fringes on a sample and each interval between the interference fringes, the interference fringes being observed when a surface stress meter (such as FSM-6000 manufactured by Toshiba Corporation) is used to observe the sample.

Third, the tempered glass sheet of the present invention preferably further comprises 0 to 50,000 ppm of TiO₂.

Fourth, the tempered glass sheet of the present invention preferably further comprises 50 to 30,000 ppm of SnO₂+SO₃+Cl. Herein, the term “SnO₂+SO₃+Cl” refers to the total amount of SnO₂, SO₃, and Cl.

Fifth, the tempered glass sheet of the present invention preferably further comprises 0 to 10,000 ppm of CeO₂ and 0 to 10,000 ppm of WO₃.

Sixth, the tempered glass sheet of the present invention preferably further comprises 0 to 500 ppm of NiO.

Seventh, the tempered glass sheet of the present invention preferably has a thickness of 0.5 to 2.0 mm.

Eighth, the tempered glass sheet of the present invention preferably has a temperature at 10^{2.5} dPa·s of 1,600° C. or less. Herein, the term “temperature at 10^{2.5} dPa·s” refers to a value obtained by measurement using a platinum sphere pull up method.

Ninth, the tempered glass sheet of the present invention preferably has a liquidus temperature of 1,100° C. or less. Herein, the term “liquidus temperature” refers to a temperature at which crystals of glass deposit after glass powder that has passed through a standard 30-mesh sieve (sieve opening: 500 μm) and remained on a 50-mesh sieve (sieve opening: 300 μm) is placed in a platinum boat and then kept in a gradient heating furnace for 24 hours.

Tenth, the tempered glass sheet of the present invention preferably has a liquidus viscosity of 10^{4.0} dPa·s or more. Herein, the term “liquidus viscosity” refers to a value obtained by measurement of the viscosity of glass at the liquidus temperature using a platinum sphere pull up method.

Eleventh, the tempered glass sheet of the present invention preferably has a density of 2.6 g/cm³ or less. Herein, the “density” may be measured by a well-known Archimedes method.

Twelfth, the tempered glass sheet of the present invention preferably has a thermal expansion coefficient in the temperature range of 30 to 380° C. of 85 to 110×10⁻⁷/° C. Herein, the term “thermal expansion coefficient in the temperature range of 30 to 380° C.” refers to a value obtained by measurement of an average thermal expansion coefficient with a dilatometer.

Thirteenth, the tempered glass sheet of the present invention preferably has a β-OH value of 0.25 mm⁻¹ or less. Herein, the term “β-OH value” refers to a value calculated from the following equation by measuring the transmittance of the glass by FT-IR.

β-OH value=(1/X)log₁₀(T₁/T₂)

X: thickness (mm)

T₁: transmittance (%) at a reference wavelength of 3,846 cm⁻¹

T₂: minimum transmittance (%) at a hydroxyl group absorption wavelength of around 3,600 cm⁻¹

Fourteenth, the tempered glass sheet of the present invention is preferably used for a protective member for a touch panel display.

Fifteenth, the tempered glass sheet of the present invention is preferably used for a cover glass for a cellular phone.

Sixteenth, the tempered glass sheet of the present invention is preferably used for a cover glass for a solar cell.

Seventeenth, the tempered glass sheet of the present invention is preferably used for a protective member for a display.

Eighteenth, the tempered glass sheet of the present invention is preferably used for an exterior component having such a form that a part or whole of the end surface of the tempered glass sheet is exposed to the outside. Herein, when an end edge region at which a surface and end surface of the tempered glass sheet cross to each other is subjected to chamfering processing, the “end surface” includes the chamfered surface of the end edge region.

Nineteenth, a tempered glass sheet of the present invention is a tempered glass sheet having a compression stress layer in a surface thereof, comprising, as a glass composition expressed in mass % in terms of oxides, 50 to 70% of SiO₂, 12 to 18% of Al₂O₃, 0 to 1% of B₂O₃, 12 to 16% of Na₂O, 3 to 7% of K₂O, 100 to 300 ppm of Fe₂O₃, 0 to 5,000 ppm of TiO₂, and 50 to 9,000 ppm of SnO₂+SO₃+Cl, and having a compression stress value of the compression stress layer of 600 MPa or more, a depth of the compression stress layer of 50 μm or more, a liquidus viscosity of 10^{5.5} dPa·s or more, a β-OH value of 0.25 mm⁻¹ or less, a spectral transmittance in terms of a thickness of 1.0 mm at a wavelength of 400 to 700 nm of 87% or more, x in xy chromaticity coordinates (illuminant C, in terms of a thickness of 1 mm) of 0.3095 to 0.3110, and y in xy chromaticity coordinates (illuminant C, in terms of a thickness of 1 mm) is 0.3160 to 0.3170.

Twentieth, a glass sheet to be tempered of the present invention is a glass sheet to be tempered, comprising, as a glass composition expressed in mass % in terms of oxides, 50 to 70% of SiO₂, 5 to 20% of Al₂O₃, 0 to 5% of B₂O₃, 8 to 18% of Na₂O, 2 to 9% of K₂O, and 30 to 1,500 ppm of Fe₂O₃, and having a spectral transmittance in terms of a thickness of 1.0 mm at a wavelength of 400 to 700 nm of 85% or more, x in xy chromaticity coordinates (illuminant C, in terms of a thickness of 1 mm) of 0.3095 to 0.3120, and y in xy chromaticity coordinates (illuminant C, in terms of a thickness of 1 mm) of 0.3160 to 0.3180.

### Advantageous Effects of Invention

According to the present invention, the content of each component in the glass composition and the glass characteristics are controlled within proper ranges, and hence the tempered glass sheet comprising a compression stress layer with a high compression stress value and having a desired color can be provided.

### BRIEF DESCRIPTION OF DRAWING

FIG. 1 A schematic cross-sectional view for illustrating Example 2 of the present invention, specifically, a schematic cross-sectional view of a glass sheet to be tempered in its thickness direction in the case where R processing has been applied to the end edge regions of the glass sheet to be tempered.

### DESCRIPTION OF EMBODIMENTS

A tempered glass sheet according to an embodiment of the present invention has a compression stress layer in a surface thereof. A method of forming a compression stress layer in a surface of glass includes a physical tempering method and a chemical tempering method. The tempered glass sheet according to this embodiment is preferably produced by the chemical tempering method.

The chemical tempering method is a method comprising introducing alkali ions each having a large ion radius into a surface of glass by ion exchange treatment at a temperature equal to or lower than the strain point of the glass. When the chemical tempering method is used to form a compression stress layer, the compression stress layer can be properly formed even in the case where a glass sheet to be tempered has a small thickness. In addition, even when the compression stress layer is formed and then the resultant tempered glass sheet is cut, the tempered glass sheet does not easily break unlike a tempered glass sheet produced by applying a physical tempering method such as an air cooling tempering method.

Further, the tempered glass sheet according to this embodiment comprises, as a glass composition expressed in mass % in terms of oxides, 50 to 75% of SiO₂, 5 to 20% of Al₂O₃, 0 to 5% of B₂O₃, 8 to 18% of Na₂O, 2 to 9% of K₂O, and 30 to 1,500 ppm of Fe₂O₃. The reason why the content range of each component is limited as described above is shown below. Note that, in the description of the content range of each component, the expression “%” means “mass %.”

SiO₂ is a component that forms a network of glass. The content of SiO₂ is 50 to 70%, preferably 52 to 68%, 55 to 68%, 55 to 65%, particularly preferably 55 to 63%. When the content of SiO₂ is too small, vitrification does not occur easily, the thermal expansion coefficient increases excessively, and the thermal shock resistance is liable to lower. On the other hand, when the content of SiO₂ is too large, the meltability and formability are liable to lower, and the thermal expansion coefficient lowers excessively, with the result that it is difficult to match the thermal expansion coefficient with those of peripheral materials.

Al₂O₃ is a component that increases the ion exchange performance and is a component that increases the strain point or Young's modulus. The content of Al₂O₃ is 5 to 20%. When the content of Al₂O₃ is too small, the ion exchange performance may not be exerted sufficiently. Thus, the lower limit range of Al₂O₃ is suitably 7% or more, 8% or more, 10% or more, particularly suitably 12% or more. On the other hand, when the content of Al₂O₃ is too large, devitrified crystals are liable to deposit in the glass, and it is difficult to form a glass sheet by an overflow down-draw method, a float method, or the like. Further, the thermal expansion coefficient lowers excessively, and it is difficult to match the thermal expansion coefficient with those of peripheral materials. In addition, the viscosity at high temperature increases and the meltability is liable to lower. Thus, the upper limit range of Al₂O₃ is suitably 18% or less, 17% or less, particularly suitably 16% or less.

B₂O₃ is a component that reduces the viscosity at high temperature and density, stabilizes glass for crystals to be unlikely precipitated, and reduces the liquidus temperature. However, when the content of B₂O₃ is too large, through ion exchange, coloring on a surface of glass called weathering occurs, water resistance lowers, the compression stress value of the compression stress layer lowers, and the depth of the compression stress layer tends to lower. Thus, the content of B₂O₃ is 0 to 5%, preferably 0 to 3%, 0 to 2%, 0 to 1.5%, 0 to 0.9%, 0 to 0.5%, particularly preferably 0 to 0.1%.

Na₂O is an ion exchange component and is a component that reduces the viscosity at high temperature to increase the meltability and formability. Na₂O is also a component that improves the denitrification resistance. The content of Na₂O is 8 to 18%. When the content of Na₂O is too small, the meltability lowers, the thermal expansion coefficient lowers, and the ion exchange performance is liable to lower. Thus, when Na₂O is added, the lower limit range of Na₂O is suitably 10% or more, 11% or more, particularly suitably 12% or more. On the other hand, when the content of Na₂O is too large, the thermal expansion coefficient becomes too large, the thermal shock resistance lowers, and it is difficult to match the thermal expansion coefficient with those of peripheral materials. Further, the strain point lowers excessively, and the glass composition loses its component balance, with the result that the devitrification resistance lowers to the worse in some cases. Thus, the upper limit range of Na₂O is suitably 17% or less, particularly suitably 16% or less.

K₂O is a component that promotes ion exchange and is a component that has a great effect of increasing the depth of the compression stress layer among alkali metal oxides. K₂O is also a component that reduces the viscosity at high temperature to increase the meltability and formability. K₂O is also a component that improves the devitrification resistance. The content of K₂O is 2 to 9%. When the content of K₂O is too small, it is difficult to obtain the above-mentioned effects. The lower limit range of K₂O is suitably 2.5% or more, 3% or more, 3.5% or more, particularly suitably 4% or more. On the other hand, when the content of K₂O is too large, the thermal expansion coefficient becomes too large, the thermal shock resistance lowers, and it is difficult to match the thermal expansion coefficient with those of peripheral materials. Further, the strain point lowers excessively, and the glass composition loses its component balance, with the result that the denitrification resistance tends to lower to the worse. Thus, the upper limit range of K₂O is suitably 8% or less, 7% or less, 6% or less, particularly suitably 5% or less.

When a tempered glass is used for an exterior component or the like having such a form that a part or the whole of the end surface of the tempered glass is exposed to the outside, it is important to regulate the content of Fe₂O₃ to 30 to 1,500 ppm, thereby controlling the color of the tempered glass. When the content of Fe₂O₃ is too small, a high-purity glass raw material needs to be used, with the result that the production cost of the tempered glass significantly increases. The lower limit range of Fe₂O₃ is suitably 0.005% or more, 0.008% or more, particularly suitably 0.01% or more. On the other hand, when the content of Fe₂O₃ is too large, the tempered glass is liable to be colored. The upper limit range of Fe₂O₃ is suitably 0.1% or less, 0.05% or less, particularly suitably 0.03% or less. Note that the content of Fe₂O₃ in a conventional tempered glass sheet is usually more than 1,500 ppm.

In addition to the above-mentioned components, for example, the following components may be added.

Li₂O is an ion exchange component and is a component that reduces the viscosity at high temperature to increase the meltability and formability and increases the Young's modulus. In addition, Li₂O has a great effect of increasing the compression stress value among alkali metal oxides. However, when the content of Li₂O becomes extremely large in a glass system comprising 5% or more of Na₂O, the compression stress value tends to lower to the worse. Further, when the content of Li₂O is too large, the liquidus viscosity lowers, the glass is liable to devitrify, and the thermal expansion coefficient increases excessively, with the result that the thermal shock resistance lowers and it is difficult to match the thermal expansion coefficient with those of peripheral materials. In addition, the viscosity at low temperature lowers excessively, and the stress relaxation occurs easily, with the result that the compression stress value lowers to the worse in some cases. Thus, the content of Li₂O is preferably 0 to 15%, 0 to 4%, 0 to 2%, 0 to 1%, 0 to 0.5%, 0 to 0.3%, particularly preferably 0 to 0.1%.

The content of Li₂O+Na₂O+K₂O is suitably 5 to 25%, 10 to 22%, 15 to 22%, particularly suitably 17 to 22%. When the content of Li₂O+Na₂O+K₂O is too small, the ion exchange performance and meltability are liable to lower. On the other hand, when the content of Li₂O+Na₂O+K₂O is too large, the glass is liable to devitrify, and the thermal expansion coefficient increases excessively, with the result that the thermal shock resistance lowers and it is difficult to match the thermal expansion coefficient with those of peripheral materials. In addition, the strain point lowers excessively, with the result that a high compression stress value is hardly achieved in some cases. Moreover, the viscosity at around the liquidus temperature lowers, with the result that a high liquidus viscosity is hardly ensured in some cases. Note that the term “Li₂O+Na₂O+K₂O” refers to the total amount of Li₂O, Na₂O, and K₂O.

MgO is a component that reduces the viscosity at high temperature to increase the meltability and formability and increases the strain point and Young's modulus, and is a component that has a great effect of increasing the ion exchange performance among alkaline earth metal oxides. However, when the content of MgO is too large, the density and thermal expansion coefficient increase, and the glass is liable to devitrify. Thus, the upper limit range of MgO is suitably 12% or less, 10% or less, 8% or less, 5% or less, particularly suitably 4% or less. Note that, when MgO is added to the glass composition, the lower limit range of MgO is suitably 0.5% or more, 1% or more, particularly suitably 2% or more.

CaO has great effects of reducing the viscosity at high temperature to enhance the meltability and formability and increasing the strain point and Young's modulus without causing any reduction in denitrification resistance as compared to other components. The content of CaO is preferably 0 to 10%. However, when the content of CaO is too large, the density and thermal expansion coefficient increase, and the glass composition loses its component balance, with the results that the glass is liable to devitrify and the ion exchange performance is liable to lower to the worse. Thus, the content of CaO is suitably 0 to 5%, 0 to 3%, particularly suitably 0 to 2.5%.

SrO is a component that reduces the viscosity at high temperature to increase the meltability and formability and increases the strain point and Young's modulus without causing any reduction in devitrification resistance. When the content of SrO is too large, the density and thermal expansion coefficient increase, the ion exchange performance lowers, and the glass composition loses its component balance, with the result that the glass is liable to devitrify to the worse. The content range of SrO is suitably 0 to 5%, 0 to 3%, 0 to 1%, particularly suitably 0 to 0.1%.

BaO is a component that reduces the viscosity at high temperature to increase the meltability and formability and increases the strain point and Young's modulus without causing any reduction in devitrification resistance. When the content of BaO is too large, the density and thermal expansion coefficient increase, the ion exchange performance lowers, and the glass composition loses its component balance, with the result that the glass is liable to devitrify to the worse. The content range of BaO is suitably 0 to 5%, 0 to 3%, 0 to 1%, particularly suitably 0 to 0.1%.

ZnO is a component that increases the ion exchange performance and is a component that has a great effect of increasing the compression stress value, in particular. Further, ZnO is a component that reduces the viscosity at high temperature without reducing the viscosity at low temperature. However, when the content of ZnO is too large, the glass manifests phase separation, the devitrification resistance lowers, the density increases, and the depth of the compression stress layer tends to decrease. Thus, the content of ZnO is preferably 0 to 6%, 0 to 5%, 0 to 1%, particularly preferably 0 to 0.5%.

When a tempered glass is used for an exterior component or the like having such a form that a part or the whole of the end surface of the tempered glass is exposed to the outside, it is preferred to regulate the content of TiO₂, thereby controlling the color of the tempered glass. TiO₂ is a component that enhances the ion exchange performance and is a component that reduces the viscosity at high temperature. However, when the content of TiO₂ is too large, the glass is liable to be colored and to denitrify. The upper limit range of TiO₂ is suitably 5% or less, 3% or less, 1% or less, 0.7% or less, 0.5% or less, particularly suitably less than 0.5%. Note that, when TiO₂ is incorporated, the lower limit range of TiO₂ is suitably 0.001% or more, particularly suitably 0.005% or more.

WO₃ is a component that is capable of controlling the color of a tempered glass by causing color fading with the addition of a color serving as a complementary color. Further, WO₃ has the property of suppressing denitrification resistance more from deteriorating as compared to TiO₂. On the other hand, when the content of WO₃ is too large, the tempered glass is liable to be colored. The upper limit range of the content of WO₃ is suitably 5% or less, 3% or less, 2% or less, 1% or less, particularly suitably 0.5% or less. Note that, when WO₃ is incorporated, the lower limit range of WO₃ is suitably 0.001% or more, particularly suitably 0.003% or more.

ZrO₂ is a component that remarkably increases the ion exchange performance and is a component that increases the viscosity around the liquidus viscosity and the strain point. However, when the content of ZrO₂ is too large, the denitrification resistance may lower remarkably and the density may increase excessively. Thus, the upper limit range of ZrO₂ is suitably 10% or less, 8% or less, 6% or less, particularly suitably 5% or less. Note that, when the ion exchange performance is to be increased, it is preferred to add ZrO₂ to the glass composition. In that case, the lower limit range of ZrO₂ is suitably 0.01% or more, 0.5% or more, 1% or more, 2% or more, particularly suitably 4% or more.

P₂O₅ is a component that increases the ion exchange performance and is a component that increases the depth of the compression stress layer, in particular. However, when the content of P₂O₅ is too large, the glass is liable to manifest phase separation. Thus, the upper limit range of P₂O₅ is suitably 10% or less, 8% or less, 6% or less, particularly preferably 5% or less.

As a fining agent, one kind or two or more kinds selected from the group consisting of As₂O₃, Sb₂O₃, CeO₂, SnO₂, F, Cl, and SO₃ (preferably the group consisting of SnO₂, Cl, and SO₃) may be added at 0 to 30,000 ppm. The content of SnO₂+SO₃+Cl is preferably 0 to 1%, 50 to 5,000 ppm, 80 to 4,000 ppm, 100 to 3,000 ppm, particularly preferably 300 to 3,000 ppm. Note that, when the content of SnO₂+SO₃+Cl is less than 50 ppm, it is difficult to obtain a fining effect. Herein, the term “SnO₂+SO₃+Cl” refers to the total amount of SnO₂, SO₃, and Cl.

The content range of SnO₂ is suitably 0 to 10,000 ppm, 0 to 7,000 ppm, particularly suitably 50 to 6,000 ppm. The content range of Cl is suitably 0 to 1,500 ppm, 0 to 1,200 ppm, 0 to 800 ppm, 0 to 500 ppm, particularly suitably 50 to 300 ppm. The content range of SO₃ is suitably 0 to 1,000 ppm, 0 to 800 ppm, particularly suitably 10 to 500 ppm.

A transition metal element (such as Co or Ni) causing the intense coloration of glass is a component that is capable of controlling the color of a tempered glass by causing color fading with the addition of a color serving as a complementary color. On the other hand, the transition metal element may deteriorate the transmittance of glass. In particular, when the glass is used for a touch panel display, when the content of the transition metal element is too large, the visibility of the touch panel display is liable to lower. Thus, it is preferred to select a glass raw material (including cullet) so that the content of a transition metal oxide is 0.5% or less, 0.1% or less, particularly 0.05% or less. Note that, when the transition metal element is incorporated, the lower limit range of the transition metal element is suitably 0.0001% or more, particularly suitably 0.0003% or more.

A rare-earth oxide such as Nb₂O₅, La₂O₃, or CeO₂ is a component that increases the Young's modulus of glass and is a component that is capable of controlling the color of a tempered glass by causing color fading with the addition of a color serving as a complementary color. However, the cost of the raw material itself therefor is high. Further, when the rare-earth oxide is added in a large amount, the denitrification resistance is liable to deteriorate. Thus, the content of the rare-earth oxide is preferably 4% or less, 3% or less, 2% or less, 1% or less, 0.5% or less. Of those, CeO₂ is a component that has a great color fading action. The lower limit range of CeO₂ is suitably 0.01% or more, 0.03% or more, 0.05% or more, 0.1% or more, particularly suitably 0.3% or more.

Further, the tempered glass sheet according to this embodiment is preferably substantially free of As₂O₃, Sb₂O₃, F, PbO, and Bi₂O₃ from environmental considerations. Herein, the gist of the phrase “substantially free of As₂O₃” resides in that As₂O₃ is not added positively as a glass component, but contamination with As₂O₃ as an impurity is allowable. Specifically, the phrase means that the content of As₂O₃ is less than 500 ppm (by mass). The gist of the phrase “substantially free of Sb₂O₃” resides in that Sb₂O₃ is not added positively as a glass component, but contamination with Sb₂O₃ as an impurity is allowable. Specifically, the phrase means that the content of Sb₂O₃ is less than 500 ppm (by mass). The gist of the phrase “substantially free of F” resides in that F is not added positively as a glass component, but contamination with F as an impurity is allowable. Specifically, the phrase means that the content of F is less than 500 ppm (by mass). The gist of the phrase “substantially free of PbO” resides in that PbO is not added positively as a glass component, but contamination with PbO as an impurity is allowable. Specifically, the phrase means that the content of PbO is less than 500 ppm (by mass). The gist of the phrase “substantially free of Bi₂O₃” resides in that Bi₂O₃ is not added positively as a glass component, but contamination with Bi₂O₃ as an impurity is allowable. Specifically, the phrase means that the content of Bi₂O₃ is less than 500 ppm (by mass).

The tempered glass sheet according to this embodiment has a spectral transmittance in terms of a thickness of 1.0 mm at a wavelength of 400 to 700 nm of 85% or more, preferably 87% or more, 89% or more, particularly preferably 90% or more. With this, the color of the tempered glass sheet is faded. Hence, when the tempered glass sheet is used for an exterior component having such a form that a part or the whole of the end surface of the tempered glass sheet is exposed to the outside, high-class appearance can be provided to the exterior component.

The tempered glass sheet according to this embodiment has a chromaticity x of 0.3095 to 0.3120, preferably 0.3096 to 0.3115, 0.3097 to 0.3110, 0.3098 to 0.3107, particularly preferably 0.3100 to 0.3107 in xy chromaticity coordinates (illuminant C, in terms of a thickness of 1 mm). With this, the color of the tempered glass sheet is faded. Hence, when the tempered glass sheet is used for an exterior component having such a form that a part or the whole of the end surface of the tempered glass sheet is exposed to the outside, high-class appearance can be provided to the exterior component.

The tempered glass sheet according to this embodiment has a chromaticity y of 0.3160 to 0.3180, preferably 0.3160 to 0.3175, 0.3160 to 0.3170, particularly preferably 0.3160 to 0.3167 in xy chromaticity coordinates (illuminant C, in terms of a thickness of 1 mm). With this, the color of the tempered glass sheet is faded. Hence, when the tempered glass sheet is used for an exterior component having such a form that a part or the whole of the end surface of the tempered glass sheet is exposed to the outside, high-class appearance can be provided to the exterior component.

In the tempered glass sheet according to this embodiment, the compression stress value of the compression stress layer is preferably 300 MPa or more, 500 MPa or more, 600 MPa or more, 700 MPa or more, particularly preferably 800 MPa or more. As the compression stress value becomes larger, the mechanical strength of the tempered glass sheet becomes higher. On the other hand, when an extremely large compression stress is formed on the surface of the tempered glass sheet, micro cracks are generated on the surface, which may reduce the mechanical strength of the tempered glass sheet to the worse. Further, a tensile stress inherent in the tempered glass sheet may increase extremely. Thus, the compression stress value of the compression stress layer is preferably 1,500 MPa or less. Note that there is a tendency that the compression stress value is increased by increasing the content of Al₂O₃, TiO₂, ZrO₂, MgO, or ZnO in the glass composition or by reducing the content of SrO or BaO in the glass composition. Further, there is a tendency that the compression stress value is increased by shortening the ion exchange time or by reducing the temperature of an ion exchange solution.

The depth of the compression stress layer is preferably 10 μm or more, 25 μm or more, 40 μm or more, particularly preferably 45 μm or more. As the depth of the compression stress layer becomes larger, the tempered glass sheet is more hardly cracked even when the tempered glass sheet has a deep flaw, and a variation in the mechanical strength becomes smaller. On the other hand, as the depth of the compression stress layer becomes larger, it becomes more difficult to cut the tempered glass sheet. Thus, the depth of the compression stress layer is preferably 500 μm or less, 200 μm or less, 150 μm or less, particularly preferably 90 μm or less. Note that there is a tendency that the depth of the compression stress layer is increased by increasing the content of K₂O or P₂O₅ in the glass composition or by reducing the content of SrO or BaO in the glass composition. Further, there is a tendency that the depth of the compression stress layer is increased by lengthening the ion exchange time or by increasing the temperature of an ion exchange solution.

In the tempered glass sheet according to this embodiment, a part or the whole of the end edge regions at which a cut surface of the tempered glass sheet and a surface thereof cross to each other is preferably subjected to chamfering processing, and a part or the whole of the end edge region at least on the viewer side is preferably subjected to chamfering processing. Note that only the end edge region on the device side or both the end edge regions on the viewer side and the device side may be subjected to chamfering processing. The chamfering processing is preferably R chamfering. In this case, R chamfering with a curvature radius of 0.05 to 0.5 mm is preferred. Further, C chamfering with a cut length of 0.05 to 0.5 mm on each side or one side is also suitable. In addition, the chamfered surface has a surface roughness Ra of preferably 1 nm or less, 0.7 nm or less, 0.5 nm or less, particularly preferably 0.3 nm or less. With this, cracks originated from end edge regions are easily prevented, and from the viewpoint of appearance, the tempered glass sheet can be suitably used for an exterior component having such a form that a part or the whole of the end surface of the tempered glass sheet is exposed to the outside. Herein, the term “surface roughness Ra” refers to a value obtained by measurement using a method in accordance with JIS B0601: 2001.

The tempered glass sheet according to this embodiment has a β-OH value of preferably 0.4 mm⁻¹ or less, 0.3 mm⁻¹ or less, 0.28 mm⁻¹ or less, 0.25 mm⁻¹ or less, particularly preferably 0.22 mm⁻¹ or less. A tempered glass sheet having a smaller β-OH value has more improved ion exchange performance.

The β-OH value of a tempered glass sheet is increased by (1) selecting a raw material having a high content of water (such as a hydroxide raw material), (2) adding water into a raw material, (3) reducing the addition amount of a component capable of decreasing the amount of water (such as Cl or SO₃) or not using the component, (4) adopting oxygen combustion or directly introducing water vapor into a melting furnace at the time of melting glass, thereby increasing the amount of water in the atmosphere inside the furnace, (5) performing water vapor bubbling in molten glass, (6) adopting a large melting furnace, or (7) reducing the flow rate of molten glass. Thus, the β-OH value can be reduced by performing the reverse operation of each of the above-mentioned operations (1) to (7). That is, the β-OH value is reduced by (8) selecting a raw material having a low content of water, (9) not adding water into a raw material, (10) increasing the addition amount of a component capable of decreasing the amount of water (such as Cl or SO₃), (11) reducing the amount of water in the atmosphere inside a furnace, (12) performing N₂ bubbling in molten glass, (13) adopting a small melting furnace, or (14) increasing the flow rate of molten glass.

The tempered glass sheet according to this embodiment has a thickness of preferably 3.0 mm or less, 2.0 mm or less, 1.5 mm or less, 1.3 mm or less, 1.1 mm or less, 1.0 mm or less, 0.8 mm or less, particularly preferably 0.7 mm or less. On the other hand, when the thickness is too small, it is difficult to obtain a desired mechanical strength. Thus, the thickness is preferably 0.1 mm or more, 0.2 mm or more, 0.3 mm or more, 0.4 mm or more, particularly preferably 0.5 mm or more.

The tempered glass sheet according to this embodiment has a density of preferably 2.6 g/cm or less, particularly preferably 2.55 g/cm³ or less. As the density becomes smaller, the weight of the tempered glass sheet can be reduced more. Note that the density is easily decreased by increasing the content of SiO₂, B₂O₃, or P₂O₅ in the glass composition or by reducing the content of an alkali metal oxide, an alkaline earth metal oxide, ZnO, ZrO₂, or TiO₂ in the glass composition.

The tempered glass sheet according to this embodiment has a thermal expansion coefficient in the temperature range of 30 to 380° C. of preferably 80 to 120×10⁻⁷/° C., 85 to 110×10⁻⁷/° C., 90 to 110×10⁻⁷/° C., particularly preferably 90 to 105×10⁻⁷/° C. When the thermal expansion coefficient is controlled within the above-mentioned ranges, it is easy to match the thermal expansion coefficient with those of members made of a metal, an organic adhesive, and the like, and the members made of a metal, an organic adhesive, and the like are easily prevented from being peeled off. Note that the thermal expansion coefficient is easily increased by increasing the content of an alkali metal oxide or an alkaline earth metal oxide in the glass composition, and in contrast, the thermal expansion coefficient is easily decreased by reducing the content of the alkali metal oxide or the alkaline earth metal oxide.

The tempered glass sheet according to this embodiment has a strain point of preferably 500° C. or more, 520° C. or more, particularly preferably 530° C. or more. As the strain point becomes higher, the heat resistance is improved more, and the disappearance of the compression stress layer more hardly occurs when the tempered glass sheet is subjected to thermal treatment. Further, as the strain point becomes higher, stress relaxation more hardly occurs during ion exchange treatment, and thus the compression stress value can be maintained more easily. Note that the strain point is easily increased by increasing the content of an alkaline earth metal oxide, Al₂O₃, ZrO₂, or P₂O₅ in the glass composition or by reducing the content of an alkali metal oxide in the glass composition.

The tempered glass sheet according to this embodiment has a temperature at 10^{4.0} dPa·s of preferably 1,280° C. or less, 1,230° C. or less, 1,200° C. or less, 1,180° C. or less, particularly preferably 1,160° C. or less. As the temperature at 10^{4.0} dPa·s becomes lower, a burden on a forming facility is reduced more, the forming facility has a longer life, and consequently, the production cost of the tempered glass sheet is more likely to be reduced. The temperature at 10^{4.0} dPa·s is easily decreased by increasing the content of an alkali metal oxide, an alkaline earth metal oxide, ZnO, B₂O₃, or TiO₂ or by reducing the content of SiO₂ or Al₂O₃.

The tempered glass sheet according to this embodiment has a temperature at 10^{2.5} dPa·s of preferably 1,620° C. or less, 1,550° C. or less, 1,530° C. or less, 1,500° C. or less, particularly preferably 1,450° C. or less. As the temperature at 10^{2.5} dPa·s becomes lower, melting at lower temperature can be carried out, and hence a burden on a glass production facility such as a melting furnace is reduced more, and the bubble quality of glass is improved more easily. That is, as the temperature at 10^{2.5} dPa·s becomes lower, the production cost of the tempered glass sheet is more likely to be reduced. Note that the temperature at 10^{2.5} dPa·s corresponds to a melting temperature. Further, the temperature at 10^{2.5} dPa·s is easily decreased by increasing the content of an alkali metal oxide, an alkaline earth metal oxide, ZnO, B₂O₃, or TiO₂ in the glass composition or by reducing the content of SiO₂ or Al₂O₃ in the glass composition.

The tempered glass sheet according to this embodiment has a liquidus temperature of preferably 1,100° C. or less, 1,050° C. or less, 1,000° C. or less, 950° C. or less, 900° C. or less, particularly preferably 880° C. or less. Note that, as the liquidus temperature becomes lower, the devitrification resistance and formability are improved more. Further, the liquidus temperature is easily decreased by increasing the content of Na₂O, K₂O, or B₂O₃ in the glass composition or by reducing the content of Al₂O₃, Li₂O, MgO, ZnO, TiO₂, or ZrO₂ in the glass composition.

The tempered glass sheet according to this embodiment has a liquidus viscosity of preferably 10^{4.0} dPa·s or more, 10^{4.4} dPa·s or more, 10^{4.8} dPa·s or more, 10^{5.0} dPa·s or more, 10^{5.4} dPa·s or more, 10^{5.6} dPa·s or more, 10^{6.0} dPa·s or more, 10^{6.2} dPa·s or more, particularly preferably 10^{6.3} dPa·s or more. Note that, as the liquidus viscosity becomes higher, the devitrification resistance and formability are improved more. Further, the liquidus viscosity is easily increased by increasing the content of Na₂O or K₂O in the glass composition or by reducing the content of Al₂O₃, Li₂O, MgO, ZnO, TiO₂, or ZrO₂ in the glass composition.

In the tempered glass sheet according to this embodiment, suitable tempered glass sheets can be specified by appropriately selecting suitable content ranges of each component and suitable amounts of water. Of those, the following tempered glass sheets are particularly suitable:

(1) a tempered glass sheet comprising, as a glass composition expressed in mass % in terms of oxides, 50 to 70% of SiO₂, 7 to 20% of Al₂O₃, 0 to 3% of B₂O₃, 10 to 18% of Na₂O, 2 to 8% of K₂O, 50 to 1,000 ppm of Fe₂O₃, 0 to 50,000 ppm of TiO₂, and 80 to 9,000 ppm of SnO₂+SO₃+Cl, and having a β-OH value of 0.5 mm⁻¹ or less;
(2) a tempered glass sheet comprising, as a glass composition expressed in mass % in terms of oxides, 50 to 70% of SiO₂, 8 to 20% of Al₂O₃, 0 to 2% of B₂O₃, 11 to 18% of Na₂O, 2 to 7% of K₂O, 80 to 500 ppm of Fe₂O₃, 0 to 30,000 ppm of TiO₂, and 100 to 8,000 ppm of SnO₂+SO₃+Cl, and having a β-OH value of 0.4 mm⁻¹ or less;
(3) a tempered glass sheet comprising, as a glass composition expressed in mass % in terms of oxides, 50 to 70% of SiO₂, 10 to 18% of Al₂O₃, 0 to 1.5% of B₂O₃, 12 to 17% of Na₂O, 3 to 7% of K₂O, 100 to 300 ppm of Fe₂O₃, 0 to 10,000 ppm of TiO₂, and 300 to 7,000 ppm of SnO₂+SO₃+Cl, and having a β-OH value of 0.4 mm⁻¹ or less; and
(4) a tempered glass sheet comprising, as a glass composition expressed in mass % in terms of oxides, 50 to 70% of SiO₂, 12 to 18% of Al₂O₃, 0 to 1% of B₂O₃, 12 to 16% of Na₂O, 3 to 7% of K₂O, 100 to 300 ppm of Fe₂O₃, 0 to 5,000 ppm of TiO₂, and 300 to 3,000 ppm of SnO₂+SO₃+Cl, and having a β-OH value of 0.3 mm⁻¹ or less.

A glass sheet to be tempered according to an embodiment of the present invention comprises, as a glass composition expressed in mass % in terms of oxides, 50 to 70% of SiO₂, 5 to 20% of Al₂O₃, 0 to 5% of B₂O₃, 8 to 18% of Na₂O, 2 to 9% of K₂O, and 30 to 1,500 ppm of Fe₂O₃, and having a spectral transmittance in terms of a thickness of 1.0 mm at a wavelength of 400 to 700 nm of 85% or more, a chromaticity x of 0.3100 to 0.3120 in xy chromaticity coordinates (illuminant C, in terms of a thickness of 1 mm), and a chromaticity y of 0.3160 to 0.3180 in xy chromaticity coordinates (illuminant C, in terms of a thickness of 1 mm). The technical features of the glass sheet to be tempered according to this embodiment are the same as the technical features of the tempered glass sheet according to this embodiment described previously. Herein, the description thereof is omitted for convenience sake.

When the glass sheet to be tempered according to this embodiment is subjected to ion exchange treatment in a KNO₃ molten salt at 430° C., it is preferred that the compression stress value of the compression stress layer in the surface be 300 MPa or more and the depth of the compression stress layer be 10 μm or more, it is more preferred that the compression stress value of the compression stress layer be 600 MPa or more and the depth of the compression stress layer be 40 μm or more, and it is particularly preferred that the compression stress value of the compression stress layer be 800 MPa or more and the depth of the compression stress layer be 60 μm or more.

When ion exchange treatment is performed, the temperature of the KNO₃ molten salt is preferably 400 to 550° C., and the ion exchange time is preferably 2 to 10 hours, particularly preferably 4 to 8 hours. With this, the compression stress layer can be properly formed easily. Note that the glass sheet to be tempered according to this embodiment has the above-mentioned glass composition, and hence the compression stress value and depth of the compression stress layer can be increased without using a mixture of a KNO₃ molten salt and an NaNO₃ molten salt or the like.

The glass sheet to be tempered and tempered glass sheet according to this embodiment can be produced as described below.

A glass sheet can be produced by first placing glass raw materials, which have been blended so as to have the above-mentioned glass composition, in a continuous melting furnace, melting the glass raw materials by heating at 1,500 to 1,600° C., fining the molten glass, and feeding the resultant to a forming apparatus, followed by forming into a sheet shape or the like and annealing.

It is preferred to adopt an overflow down-draw method as a method of forming glass into a sheet shape. The overflow down-draw method is a method by which glass sheets can be massively produced at low cost and by which a large glass sheet can be easily produced.

Various forming methods other than the overflow down-draw method may also be adopted. For example, forming methods may be adopted, such as a float method, a down-draw method (such as a slot down method or a re-draw method), a roll-out method, and a press method.

Next, the resultant glass sheet is subjected to tempering treatment, thereby being able to produce a tempered glass sheet. The glass sheet may be cut into pieces having a predetermined size before the tempering treatment, but the cutting after the tempering treatment is advantageous in terms of cost.

The tempering treatment is preferably ion exchange treatment. Conditions for the ion exchange treatment are not particularly limited, and optimum conditions may be selected in view of, for example, the viscosity properties, applications, thickness, and inner tensile stress of a glass sheet. The ion exchange treatment can be performed, for example, by immersing a glass sheet in a KNO₃ molten salt at 400 to 550° C. for 1 to 8 hours. Particularly when the ion exchange of K ions in the KNO₃ molten salt with Na components in the glass sheet is performed, it is possible to form efficiently a compression stress layer in a surface of the glass sheet.

### Example 1

Examples of the present invention are hereinafter described. Note that the following examples are merely illustrative. The present invention is by no means limited to the following examples.

Tables 1 to 3 show Examples of the present invention (Sample Nos. 1 to 16).

TABLE 1

| | | Example | | | | | |
|---|---|---|---|---|---|---|---|
| | | No. 1 | No. 2 | No. 3 | No. 4 | No. 5 | No. 6 |
| wt % | SiO₂ | 57.4 | 57.3 | 56.5 | 58.5 | 57.2 | 58.2 |
| | Al₂O₃ | 12.9 | 13.0 | 13.0 | 13.3 | 13.0 | 14.0 |
| | B₂O₃ | 2.0 | 2.0 | 2.0 | — | — | — |
| | Li₂O | — | 0.1 | 1.0 | 0.1 | 0.1 | 0.1 |
| | Na₂O | 14.5 | 14.5 | 14.5 | 14.8 | 14.5 | 13.5 |
| | K₂O | 5.0 | 5.0 | 5.0 | 5.1 | 7.0 | 6.5 |
| | M_{g}O | 2.0 | 2.0 | 2.0 | 2.0 | 2.0 | 2.0 |
| | CₐO | 2.0 | 2.0 | 2.0 | 2.0 | 2.0 | 2.0 |
| | ZᵣO₂ | 4.0 | 4.0 | 4.0 | 4.1 | 4.0 | 3.5 |
| ppm | Cl | — | 500 | — | 300 | — | 200 |
| | SnO₂ | 2,000 | — | — | — | 1,000 | 1,500 |
| | SO₃ | — | — | 200 | 500 | 300 | — |
| | Fe₂O₃ | 150 | 160 | 120 | 190 | 140 | 150 |
| | TiO₂ | 50 | 40 | 30 | 70 | 60 | 50 |

| ρ (g/cm³) | | 2.54 | 2.55 | 2.56 | 2.55 | 2.56 | 2.52 |
|---|---|---|---|---|---|---|---|
| α (×10⁻⁷/° C.) | | 99 | 100 | 100 | 101 | 106 | 101 |
| Ps (° C.) | | 530 | 524 | 485 | 533 | 523 | 534 |
| Ta (° C.) | | 571 | 565 | 524 | 577 | 566 | 579 |
| Ts (° C.) | | 769 | 765 | 714 | 791 | 777 | 798 |
| 10^{4.0} dPa · s (° C.) | | 1,115 | 1,110 | 1,052 | 1,140 | 1,123 | 1,156 |
| 10^{3.0} dPa · s (° C.) | | 1,296 | 1,289 | 1,231 | 1,319 | 1,300 | 1,339 |
| 10^{2.5} dPa · s (° C.) | | 1,411 | 1,403 | 1,345 | 1,432 | 1,412 | 1,455 |
| TL (° C.) | | 880 | 880 | 870 | 880 | 860 | 880 |
| log₁₀ηTL (dPa · s) | | 6.0 | 6.0 | 5.5 | 6.3 | 6.4 | 6.5 |
| β-OH (mm⁻¹) | | 0.25 | 0.26 | 0.22 | 0.20 | 0.28 | 0.22 |
| CS (MPa) | | 925 | 910 | 737 | 893 | 822 | 884 |
| DOL (μm) | | 37 | 35 | 27 | 42 | 47 | 47 |
| Transmittance | Wavelength | 91 | 91 | 91 | 91 | 91 | 91 |
| (%) | 400 nm | | | | | | |
| | Wavelength | 92 | 92 | 92 | 92 | 92 | 92 |
| | 550 nm | | | | | | |
| | Wavelength | 92 | 92 | 92 | 92 | 92 | 92 |
| | 700 nm | | | | | | |

| | | | | | | |
|---|---|---|---|---|---|---|
| Chromaticity x | 0.3105 | 0.3104 | 0.3103 | 0.3105 | 0.3104 | 0.3104 |
| Chromaticity y | 0.3165 | 0.3166 | 0.3164 | 0.3166 | 0.3166 | 0.3166 |

TABLE 2

| | | Example | | | | |
|---|---|---|---|---|---|---|
| | | No. 7 | No. 8 | No. 9 | No. 10 | No. 11 |
| wt % | SiO₂ | 59.1 | 58.0 | 58.1 | 58.4 | 57.8 |
| | Al₂O₃ | 12.0 | 13.6 | 13.3 | 13.0 | 14.0 |
| | B₂O₃ | — | — | — | — | — |
| | Li₂O | 0.1 | 0.1 | 0.1 | 0.1 | 0.1 |
| | Na₂O | 13.0 | 14.8 | 14.8 | 14.5 | 14.5 |
| | K₂O | 7.0 | 5.5 | 5.5 | 5.5 | 5.5 |
| | M_{g}O | 2.0 | 2.0 | 2.0 | 2.0 | 2.0 |
| | CₐO | 2.0 | 1.4 | 1.4 | 2.0 | 2.0 |
| | ZᵣO₂ | 4.5 | 4.4 | 4.7 | 4.5 | 4.0 |
| ppm | Cl | — | 100 | — | — | — |
| | SnO₂ | 3,000 | 1,500 | 1,000 | — | — |
| | SO₃ | — | — | — | 300 | 400 |
| | Fe₂O₃ | 150 | 210 | 170 | 120 | 110 |
| | TiO₂ | 50 | 80 | 30 | 20 | 30 |
| ρ (g/cm³) | | 2.54 | 2.54 | 2.54 | 2.55 | 2.54 |
| α (×10⁻⁷/° C.) | | 102 | 103 | 103 | 102 | 102 |
| Ps (° C.) | | 532 | 533 | 534 | 533 | 536 |
| Ta (° C.) | | 576 | 579 | 579 | 577 | 580 |
| Ts (° C.) | | 794 | 798 | 799 | 793 | 796 |
| 10^{4.0} dPa · s (° C.) | | 1,149 | 1,152 | 1,149 | 1,142 | 1,147 |
| 10^{3.0} dPa · s (° C.) | | 1,330 | 1,333 | 1,327 | 1,319 | 1,326 |
| 10^{2.5} dPa · s (° C.) | | 1,445 | 1,449 | 1,441 | 1,431 | 1,440 |
| TL (° C.) | | 880 | 870 | 880 | 880 | 870 |
| log₁₀ηTL (dPa · s) | | 6.4 | 6.6 | 6.5 | 6.4 | 6.5 |
| β-OH (mm⁻¹) | | 0.22 | 0.25 | 0.20 | 0.19 | 0.19 |
| CS (MPa) | | 880 | 880 | 873 | 906 | 921 |
| DOL (μm) | | 49 | 49 | 48 | 43 | 44 |
| Transmittance | Wavelength | 91 | 91 | 91 | 91 | 91 |
| (%) | 400 nm | | | | | |
| | Wavelength | 92 | 92 | 92 | 92 | 92 |
| | 550 nm | | | | | |
| | Wavelength | 92 | 92 | 92 | 92 | 92 |
| | 700 nm | | | | | |

| | | | | | |
|---|---|---|---|---|---|
| Chromaticity x | 0.3105 | 0.3105 | 0.3105 | 0.3103 | 0.3103 |
| Chromaticity y | 0.3165 | 0.3166 | 0.3165 | 0.3164 | 0.3164 |

TABLE 3

| | | Example | | | | |
|---|---|---|---|---|---|---|
| | | No. 12 | No. 13 | No. 14 | No. 15 | No. 16 |
| wt % | SiO₂ | 58.4 | 58.4 | 58.4 | 58.4 | 58.4 |
| | Al₂O₃ | 13 | 13 | 13 | 13 | 13 |
| | B₂O₃ | — | — | — | — | — |
| | Li₂O | 0.1 | 0.1 | 0.1 | 0.1 | 0.1 |
| | Na₂O | 14.5 | 14.5 | 14.5 | 14.5 | 14.5 |
| | K₂O | 5.5 | 5.5 | 5.5 | 5.5 | 5.5 |
| | M_{g}O | 2 | 2 | 2 | 2 | 2 |
| | CₐO | 2 | 2 | 2 | 2 | 2 |
| | ZᵣO₂ | 4.5 | 4.5 | 4.5 | 4.5 | 4.5 |
| ppm | Cl | — | — | — | — | — |
| | SnO₂ | 3,000 | 3,000 | 3,000 | 3,000 | 3,000 |
| | SO₃ | — | — | — | — | — |
| | Fe₂O₃ | 230 | 230 | 230 | 230 | 230 |
| | TiO₂ | 60 | 5,000 | 60 | 60 | 60 |
| | CeO₂ | — | — | 5,000 | — | — |
| | WO₃ | — | — | — | 5,000 | — |
| | NiO | — | — | — | — | 50 |
| Transmittance | Wavelength | 91 | 91 | 91 | 90 | 91 |
| (%) | 400 nm | | | | | |
| | Wavelength | 91 | 91 | 91 | 91 | 90 |
| | 550 nm | | | | | |
| | Wavelength | 90 | 90 | 91 | 90 | 90 |
| | 700 nm | | | | | |

| | | | | | |
|---|---|---|---|---|---|
| Chromaticity x | 0.3099 | 0.3100 | 0.3102 | 0.3101 | 0.3103 |
| Chromaticity y | 0.3163 | 0.3165 | 0.3164 | 0.3165 | 0.3166 |

Table 4 shows the raw material composition of Sample Nos. 12 to 16.

TABLE 4

Silicon oxide
Aluminum oxide
Sodium carbonate
Potassium carbonate
Lithium carbonate
Magnesium oxide
Calcium carbonate
Zirconium silicate
Tin oxide
Titanium oxide
Cerium oxide
Tungsten oxide
Nickel oxide

Each of the samples in the tables was produced as described below. First, glass raw materials were blended so as to have glass compositions shown in the tables, and melted at 1,580° C. for 8 hours using a platinum pot. Thereafter, the resultant molten glass was cast on a carbon plate and formed into a sheet shape. The resultant glass sheet was evaluated for its various properties.

The density ρ is a value obtained by measurement using a well-known Archimedes method.

The thermal expansion coefficient α is a value obtained by measurement of an average thermal expansion coefficient in the temperature range of 30 to 380° C. using a dilatometer.

The strain point Ps and the annealing point Ta are values obtained by measurement based on a method of ASTM C336.

The softening point Ts is a value obtained by measurement based on a method of ASTM C338.

The temperatures at viscosities at high temperature of 10^{4.0} dPa·s, 10^{3.0} dPa·s, and 10^{2.5} dPa·s are values obtained by measurement using a platinum sphere pull up method.

The liquidus temperature TL is a value obtained by measurement of a temperature at which crystals of glass deposit after glass powder that has passed through a standard 30-mesh sieve (sieve opening: 500 μm) and remained on a 50-mesh sieve (sieve opening: 300 μm) is placed in a platinum boat and then kept in a gradient heating furnace for 24 hours.

The liquidus viscosity log₁₀η_{TL} is a value obtained by measurement of the viscosity of glass at the liquidus temperature using a platinum sphere pull up method.

As evident from Tables 1, 2, and 3, each of Sample Nos. 1 to 16 having a density of 2.56 g/cm³ or less and a thermal expansion coefficient of 99 to 106×10⁻⁷/° C. was found to be suitable for a material for a tempered glass sheet, i.e., a glass sheet to be tempered.

Further, each of the samples has a liquidus viscosity of 10^{5.5} dPa·s or more, and hence is satisfactory in formability. In addition, each of the samples has a temperature at 10^{4.0} dPa·s of 1,156° C. or less, and hence reduces a burden on a forming facility. Moreover, each of the samples has a temperature at 10^{2.5} dPa·s of 1,455° C. or less, and hence is expected to allow a large number of glass sheets to be produced at low cost with high productivity. Note that the glass compositions of a surface layer of a glass sheet before and after ion exchange treatment are different from each other microscopically, but the glass composition of the whole glass does not substantially change before and after the ion exchange treatment.

Subsequently, both surfaces of each of the samples were subjected to optical polishing, and then subjected to ion exchange treatment through immersion in a KNO₃ molten salt at 440° C. for 6 hours. After the ion exchange treatment, the surface of each of the samples was washed. Then, the compression stress value CS and depth DOL of a compression stress layer in the surface were calculated from the number of interference stripes and each interval between the interference fringes, the interference fringes being observed with a surface stress meter (FSM-6000 manufactured by Toshiba Corporation). In the calculation, the refractive index and optical elastic constant of each of the samples were set to 1.52 and 28 [(nm/cm)/MPa], respectively.

As evident from Tables 1 to 3, when each of Sample Nos. 1 to 16 was subjected to ion exchange treatment using the KNO₃ molten salt, the CS and DOL of each of the samples were found to be 737 MPa or more and 27 μm or more, respectively.

The transmittance of a tempered glass sheet (1 mm) whose both surfaces had been subjected to mirror polishing was measured by FT-IR. After that, the β-OH value thereof was calculated by using the following equation.

β-OH value=(1/X)log₁₀(T₁/T₂)

X: thickness (mm)

T₁: transmittance (%) at a reference wavelength of 3,846 cm⁻¹

T₂: minimum transmittance (%) at a hydroxyl group absorption wavelength of around 3,600 cm⁻¹

Both surfaces of each of the samples were subjected to mirror polishing so that each of the samples had a thickness of 1.0 mm. Then, the spectral transmittance thereof was measured at a wavelength of 400 to 700 nm. UV-3100 PC (manufactured by Shimadzu Corporation) was used as a measurement apparatus and the measurement was performed at a slit width of 2.0 nm at a medium scan speed at a sampling pitch of 0.5 nm. Further, the same apparatus was used to evaluate the chromaticity of each of the samples. Note that illuminant C was used as an illuminant.

As evident from Tables 1 to 3, each of Sample Nos. 1 to 16 had a spectral transmittance at a wavelength of 400 to 700 nm of 90% or more, and had x and y in xy chromaticity coordinates of 0.3099 to 0.3105 and 0.3163 to 0.3166, respectively.

### Example 2

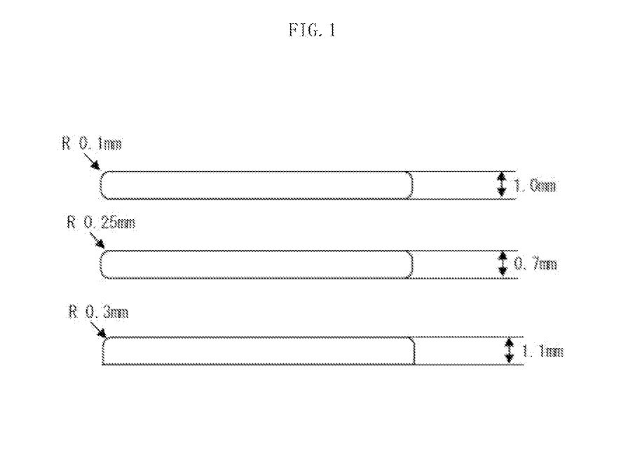

Glass raw materials were blended so that the glass composition shown in No. 10 of Table 2 was achieved. After that, the blended glass materials were formed into glass sheets by an overflow down-draw method so that the glass sheets have a thickness of 1.0 mm, 0.7 mm, and 1.1 mm, respectively. Thus, glass sheets to be tempered were produced. Subsequently, R chamfering processing with a curvature radius of 0.1 mm was applied to the whole of the end edge regions on the viewer side and the device side in the resultant glass sheet to be tempered (having a thickness of 1.0 mm). Further, R chamfering processing with a curvature radius of 0.25 mm was applied to the whole of the end edge regions on the viewer side and the device side in the resultant glass sheet to be tempered (having a thickness of 0.7 mm). Besides, R chamfering processing with a curvature radius of 0.3 mm was applied to the whole of the end edge region on the viewer side in the resultant glass sheet to be tempered (having a thickness of 1.1 mm). For reference, FIG. 1 illustrates a schematic cross-sectional view of a glass sheet to be tempered in its thickness direction in the case where R chamfering processing has been applied to the end edge regions of the glass sheet to be tempered as described above.

### INDUSTRIAL APPLICABILITY

The tempered glass sheet of the present invention is suitable for a cover glass of a cellular phone, a digital camera, a PDA, or the like, or a glass substrate for a touch panel display or the like. Further, the tempered glass sheet of the present invention can be expected to find use in applications requiring a high mechanical strength, for example, window glass, a substrate for a magnetic disk, a substrate for a flat panel display, a cover glass for a solar cell, a cover glass for a solid-state image sensing device, and tableware, in addition to the above-mentioned applications.

1. A tempered glass sheet having a compression stress layer in a surface thereof, comprising, as a glass composition expressed in mass % in terms of oxides, 50 to 70% of SiO₂, 5 to 20% of Al₂O₃, 0 to 5% of B₂O₃, 8 to 18% of Na₂O, 2 to 9% of K₂O, and 30 to 1,500 ppm of Fe₂O₃, and having a spectral transmittance in terms of a thickness of 1.0 mm at a wavelength of 400 to 700 nm of 85% or more, a chromaticity x of 0.3095 to 0.3120 in xy chromaticity coordinates (illuminant C, in terms of a thickness of 1 mm), and a chromaticity y of 0.3160 to 0.3180 in xy chromaticity coordinates (illuminant C, in terms of a thickness of 1 mm).

2. The tempered glass sheet according to claim 1, wherein a compression stress value of the compression stress layer is 400 MPa or more, and a depth of the compression stress layer is 30 μm or more.

3. The tempered glass sheet according to claim 1, further comprising 0 to 50,000 ppm of TiO₂.

4. The tempered glass sheet according to claim 1, further comprising 50 to 30,000 ppm of SnO₂+SO₃+Cl.

5. The tempered glass sheet according to claim 1, further comprising 0 to 10,000 ppm of CeO₂ and 0 to 10,000 ppm of WO₃.

6. The tempered glass sheet according to claim 1, further comprising 0 to 500 ppm of NiO.

7. The tempered glass sheet according to claim 1, wherein the tempered glass sheet has a thickness of 0.5 to 2.0 mm.

8. The tempered glass sheet according to claim 1, wherein the tempered glass sheet has a temperature at 10^{2.5} dPa·s of 1,600° C. or less.

9. The tempered glass sheet according to claim 1, wherein the tempered glass sheet has a liquidus temperature of 1,100° C. or less.

10. The tempered glass sheet according to claim 1, wherein the tempered glass sheet has a liquidus viscosity of 10^{4.0} dPa·s or more.

11. The tempered glass sheet according to claim 1, wherein the tempered glass sheet has a density of 2.6 g/cm³ or less.

12. The tempered glass sheet according to claim 1, wherein the tempered glass sheet has a thermal expansion coefficient of 85 to 110×10⁻⁷/° C. in a temperature range of from 30 to 380° C.

13. The tempered glass sheet according to claim 1, wherein the tempered glass sheet has a β-OH value of 0.25 mm⁻¹ or less.

14. The tempered glass sheet according to claim 1, wherein the tempered glass sheet is used for a protective member for a touch panel display.

15. The tempered glass sheet according to claim 1, wherein the tempered glass sheet is used for a cover glass for a cellular phone.

16. The tempered glass sheet according to claim 1, wherein the tempered glass sheet is used for a cover glass for a solar cell.

17. The tempered glass sheet according to claim 1, wherein the tempered glass sheet is used for a protective member for a display.

18. The tempered glass sheet according to claim 1, wherein the tempered glass sheet is used for an exterior component having such a form that a part or whole of an end surface of the tempered glass sheet is exposed to an outside.

19. A tempered glass sheet having a compression stress layer in a surface thereof, comprising, as a glass composition expressed in mass % in terms of oxides, 50 to 70% of SiO₂, 12 to 18% of Al₂O₃, 0 to 1% of B₂O₃, 12 to 16% of Na₂O, 3 to 7% of K₂O, 100 to 300 ppm of Fe₂O₃, 0 to 5,000 ppm of TiO₂, and 50 to 9,000 ppm of SnO₂+SO₃+Cl, and having a compression stress value of the compression stress layer of 600 MPa or more, a depth of the compression stress layer of 50 μm or more, a liquidus viscosity of 10^{5.5} dPa·s or more, a β-OH value of 0.25 mm⁻¹ or less, a spectral transmittance in terms of a thickness of 1.0 mm at a wavelength of 400 to 700 nm of 87% or more, a chromaticity x of 0.3095 to 0.3110 in xy chromaticity coordinates (illuminant C, in terms of a thickness of 1 mm), and a chromaticity y of 0.3160 to 0.3170 in xy chromaticity coordinates (illuminant C, in terms of a thickness of 1 mm).

20. A glass sheet to be tempered, comprising, as a glass composition expressed in mass % in terms of oxides, 50 to 70% of SiO₂, 5 to 20% of Al₂O₃, 0 to 5% of B₂O₃, 8 to 18% of Na₂O, 2 to 9% of K₂O, and 30 to 1,500 ppm of Fe₂O₃, and having a spectral transmittance in terms of a thickness of 1.0 mm at a wavelength of 400 to 700 nm of 85% or more, a chromaticity x of 0.3095 to 0.3120 in xy chromaticity coordinates (illuminant C, in terms of a thickness of 1 mm), and a chromaticity y of 0.3160 to 0.3180 in xy chromaticity coordinates (illuminant C, in terms of a thickness of 1 mm).
